(19) United States
(12) Patent Application Publication
(10) Pub. No.: US 2015/0019401 A1
(43) Pub. Date: Jan. 15, 2015

(54) INTEGRATED CREDIT DECISION PLATFORM

(71) Applicant: Bank of America Corporation, Charlotte, NC (US)

(72) Inventors: Basawaraj Swamy Kollur, West Chester, PA (US); Partha Sarathi Dhar, Chester Springs, PA (US); Randoll Scott Beavers, New London, PA (US); William R. Grasch, New Castle, DE (US); Daniel Lee Wadsworth, Washington, DC (US)

(21) Appl. No.: 13/939,896

(22) Filed: Jul. 11, 2013

(51) Int. Cl. G06Q 40/02

(52) U.S. Cl. CPC G06Q 40/025
USPC 705/38

(57) ABSTRACT

Methods, systems, and computer-readable media for providing an integrated credit decision platform are presented. An integrated credit decision platform may integrate customer data across a variety of areas. For example, a customer may have a credit line, a checking account, a mortgage, or other suitable financial accounts with a financial institution. The integrated platform may make customer data across accounts available during a credit decision. In an embodiment, an organization, such as a financial institution, may receive a credit request from a customer. The credit request may include a request to change the status of the customer's credit with the financial institution. Integrated data may be accessed for the customer. For example, one or more of a checking account balance, a saving's account balance, and credit line, a payment history, and other suitable data may be accessed. A decision whether to grant or deny the customer's credit request may be based on the accessed integrated data.

### BACKGROUND

Aspects of the disclosure relate to computer hardware and software. In particular, one or more aspects of the disclosure generally relate to computer hardware and software that can be used to provide an integrated credit decision platform.

A financial institution, such as a bank, may provide various forms of credit to its customers. Such credit may take the form of credit cards, lines of credit (home equity line of credit, business loan, and the like), and any other suitable credit. As such, customers may send requests to the financial institution to secure new credit or adjust existing credit. In assessing such credit requests, a financial institution may attempt to determine a risk associated with the request.

Accordingly, a financial institution may seek to access financial data in order to determine whether to permit or deny a credit request. For example, issuing credit to a customer may include retrieving a new credit report for the customer in order to determine the customer's credit history. However, additional types of financial data may be useful in determining a credit risk. In addition, a new credit report may not always be necessary in determining a credit decision. Thus, a need exists to efficiently access and analyze various forms of financial data in order to determine a credit decision about a credit request.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects of the disclosure provide various techniques that enable determining a credit decision using an integrated credit decision platform.

Methods, systems, and computer-readable media for providing an integrated credit decision platform are presented. An integrated credit decision platform may integrate customer data across a variety of areas. For example, a customer may have a credit line, a checking account, a mortgage, or other suitable financial accounts with a financial institution. The integrated platform may make customer data across accounts available during a credit decision.

In an embodiment, an organization, such as a financial institution, may receive a credit request from a customer. The credit request may include a request to change the status of the customer's credit with the financial institution. Integrated data may be accessed for the customer. For example, one or more of a checking account balance, a saving's account balance, and credit line, a payment history, and other suitable data may be accessed. A decision whether to grant or deny the customer's credit request may be based on the accessed integrated data.

In an embodiment, the integrated data available for a customer may be analyzed, and it may be determined whether additional data should be retrieved. For example, it may be determined whether a credit report should be pulled from one or more credit bureaus or whether other third party data should be retrieved.

In an embodiment, it may be determined whether an automated decision should be made for the received credit request. For example, if a confidence level for an automated credit decision is above a threshold, an automated decision may be made for the received credit request. If the confidence level for the automated credit decision is below a threshold, the decision may be routed for additional processing, such as manual processing.

In an embodiment, a credit status may be monitored for a customer and a change in credit risk may be detected with a customer. Credit accounts for the customer may be accessed and a credit risk for the accessed accounts may be analyzed. Based on the analysis, it may be determined whether one or more of the accessed accounts should be altered. For example, it may be determined that a line of credit should be reduced for a customer.

In an embodiment, once the integrated credit data for a customer is analyzed, it may be determined whether an automated decision should be made for the credit request.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment according to an embodiment.

FIG. 1B illustrates another example operating environment according to an embodiment.

FIG. 2 illustrates an integrated credit decision platform architecture according to an embodiment.

FIG. 3 illustrates an example process for determining a credit decision according to an embodiment.

FIG. 4 illustrates an example process for determining an automated credit decision according to an embodiment.

FIG. 5 illustrates an example process for assessing credit risk across customer accounts according to an embodiment.

### DETAILED DESCRIPTION

In the following description of various embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

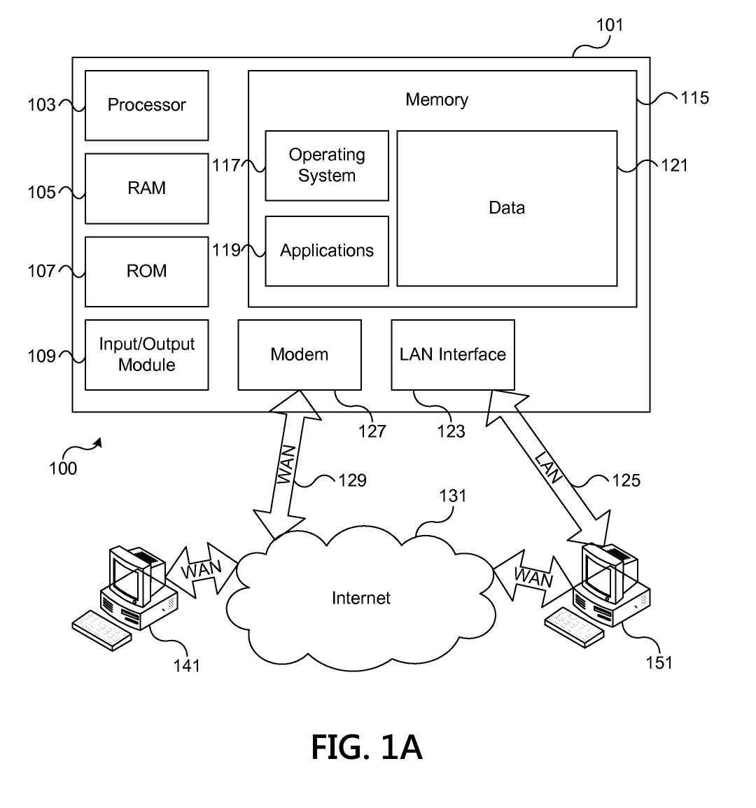

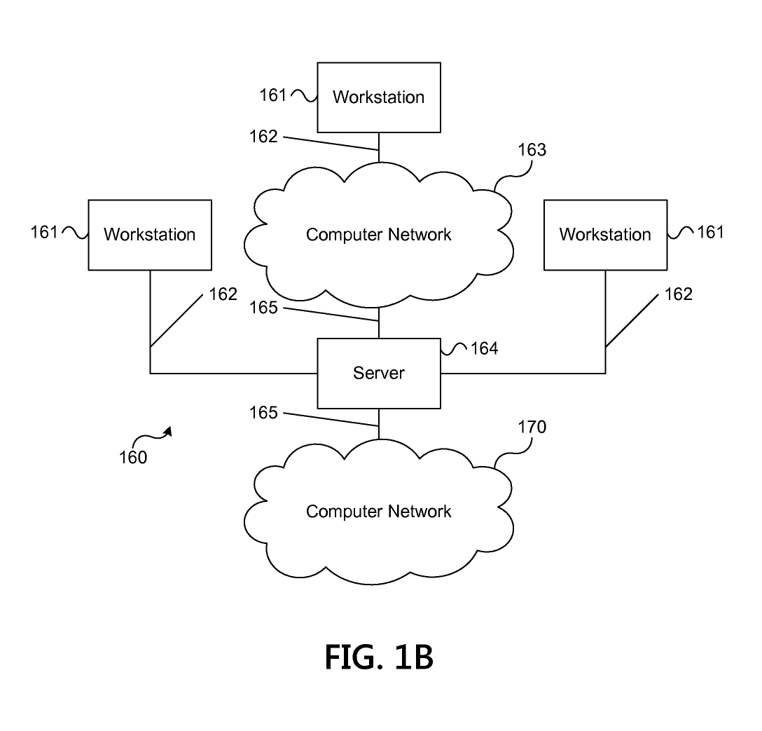

As noted above, certain embodiments are discussed herein that relate determining a credit decision using an integrated credit decision platform. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

In an embodiment, an organization, such as a bank or a financial institution, may provide financial services to a plurality of customers. For example, a bank may administer a plurality of financial accounts for a customer. These financial accounts may comprise a debit account (e.g., a checking account, a savings account, or the like), a retirement account (e.g., a 401k, individual retirement account (IRA), roth IRA, or the like), a line a credit or a loan (e.g., a mortgage, home equity line of credit, a credit card, or the like), an investment account (e.g., a certificate of deposit, trading account, or the like), and any other suitable account.

The customers may submit requests to the financial institution that are related to credit. For example, customers may submit a request for a line of credit, a request for a change in credit, or any other suitable credit request. To service these requests, the financial institution may make credit determinations about the customer and the request, such as a creditworthiness of the customer.

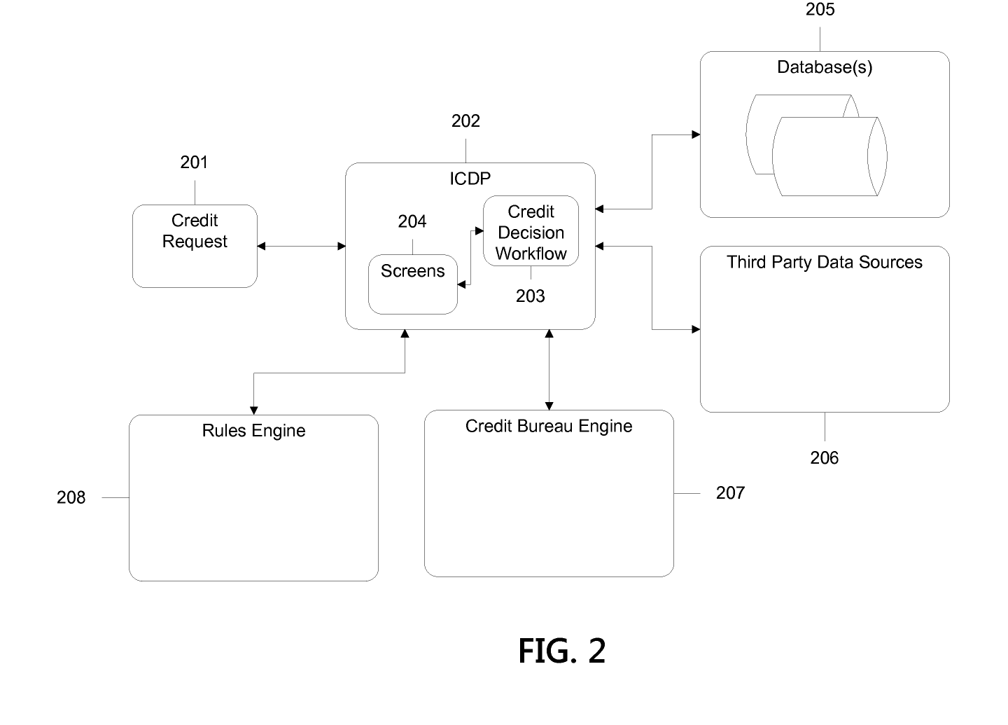

In an embodiment, the financial institution may access data from a plurality of customer accounts, and/or may access third party data, in order to determine whether to grant the credit request received from the customer. FIG. 2 illustrates an example system integrated credit decision framework for determining a credit decision in accordance with an embodiment. The framework of FIG. 2 includes credit request 201, integrated credit decision platform 202, credit decision workflow 203, screens 204, database(s) 205, third party data sources 206, credit bureau engine 207, and rules engine 208. In an embodiment, credit request 201 may be received at integrated credit decision platform 202 and may be routed to credit decision workflow 203. Credit decision workflow 203 may access one or more of database(s) 205, third party data sources 206, credit bureau engine 207, and rules engine 208 in order to make a determination about credit request 201.

Database(s) 205 may store customer data for the customer of the financial institution. For example, customer data may comprise account data, such as a credit line, a balance, a payment history, and any other suitable account data for customer accounts. In such an example, account data may comprise data from a debit account, a credit account, a retirement account, an investment account, and any other suitable account. The accounts may be administered by the financial institution receiving credit request 201. Customer data may also comprise personal data, such as a demographic, an income, an occupation, a citizenship, a residency status, and any other suitable personal data. In addition, customer data may comprise relationship data with the financial institution, such as a balance across accounts, an investment balance across accounts, a mortgage balance, delinquencies across accounts, credit line across accounts, payment history across accounts, overdraft on deposits across accounts, charge-offs across accounts, individual trade details, such as stock market trades, consumer alerts, public records, bankruptcy records, credit inquiries, and a depth and tenure of the relationship with the customer. For example, a depth and tenure of the relationship may comprise the number of years the customer has been a customer of the financial institution, the number of accounts with the financial institution, the types of accounts with the financial institution, such as personal, business, mortgages, car loans, and the like, and other types of suitable information. In an embodiment, the data stored in database(s) 205 may be stored in any suitable manner, such as in a distributed manner. In an example, the data may be stored in a system of records.

In another example, customer data may comprise recent credit bureau data, such as a FICO score, reasons impacting the FICO score, payment delinquency, total line across credit trades, total balance across credit trades, charge-offs, and bankruptcy. Credit bureau data may also comprise live data from a credit bureau.

In an embodiment, screens 204 may comprise customer information monitored from a user. Interactions with one or more users may be monitored in order to update the customer data stored in database(s) 205. For example, personal data, such as demographic information, income, or other personal information, may be updated based on data monitored from one or more users.

In an embodiment, third party data sources 206 may provide additional data used in order to make a decision about a credit request. For example, third party data sources 206 may comprise sources such as ID Analytics®, Visa Issuers' Clearinghouse Service (ICS)®, and any other suitable third party data source. Third party data sources 206 may be polled in order to make a decision about a credit request.

In an embodiment, credit bureau engine 207 may communicate with one or more credit bureaus in order to pull a credit report for a customer. For example, credit bureau engine 207 may communicate with one or more credit bureaus in order to pull one or more reports from the bureaus. The pulled report may be used to update database 205. A credit bureau may comprise a third party source.

In an embodiment, rules engine 208 may store one or more rules used to determine a credit decision for a received customer credit request. For example, a credit request may comprise a request to increase a line of credit for a consumer credit card, and rules engine 208 may comprise rules used to make a determination about the credit request. The rules may comprise allowing the increase in the line of credit if credit data for the customer, such as data stored in database 205 or data from third party data sources 206, meets certain requirements. For instance, an increase in a line of credit for a consumer credit card may require a customer with a minimum FICO score, a minimum balance for a checking account, a maximum exposure for existing credit, a maximum number of delinquencies, a maximum number of write-offs, a combination of these, or any other suitable combination of requirements.

In an embodiment, the rules may be based on the type of credit request received. For example, a first set of rules may be used to determine whether to permit or deny a request to modify existing credit, such as a request to increase a line of credit, and a second set of rules may be used to determine whether to permit or deny a request to modify existing credit, such as a request for a new line of credit. In another embodiment, a first set of rules may be used to determine whether to permit or deny a request for a personal loan and a second set of rules may be used to determine whether to permit or deny a request for a business loan.

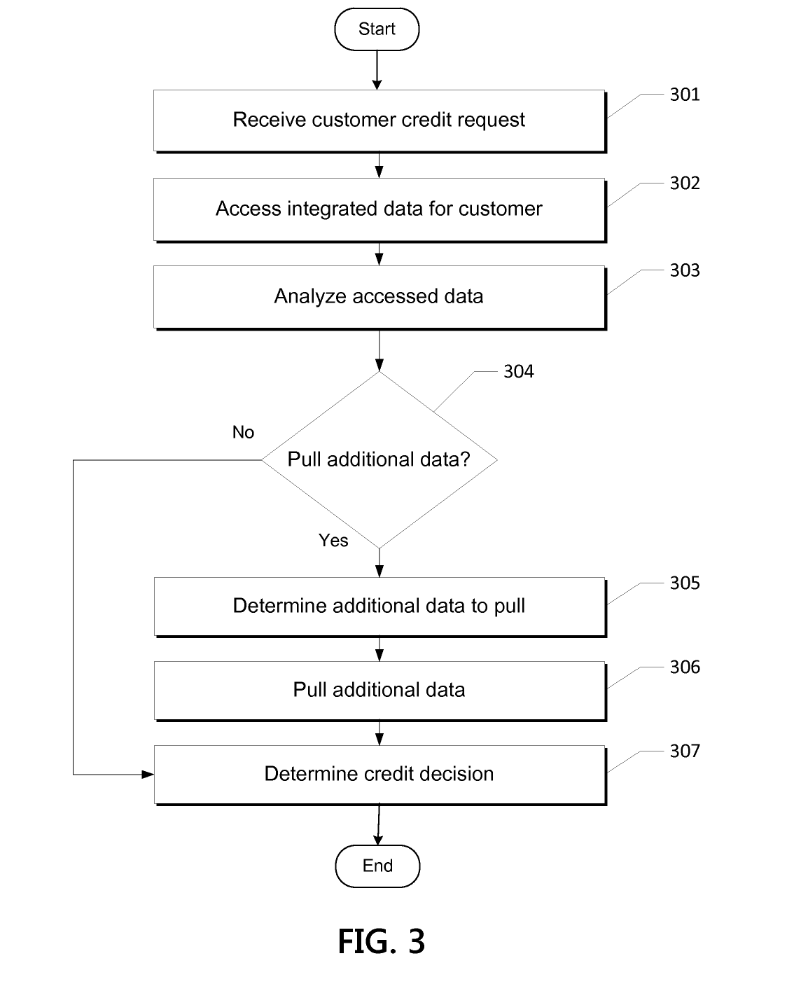

FIG. 3 illustrates an example method for determining a credit decision in accordance with an embodiment. In an embodiment, the example system integrated credit decision framework illustrated in FIG. 2 may perform the process of FIG. 3. The process of FIG. 3 may start at step 301, where a credit request is received. For example, credit request 201 may be received at integrated credit decision platform 202. The received credit request may comprise a personal credit request or a business credit request. For example, the a personal credit request may comprise a request to issue and/or update a consumer credit card, a request for a home equity line of credit, or any other suitable personal credit request. A business credit request may comprise a request to issue and/or update a business credit card, a request for a business loan, or any other suitable business credit request.

The process of FIG. 3 may proceed from step 301 to step 302, where integrated data for the customer may be accessed. For example, account data for the customer from database 205 may be accessed. In an embodiment, any data for the customer stored in database 205 may be accessed. The process of FIG. 3 may proceed from step 302 to step 303, where the accessed data may be analyzed. For example, data from database 205 may be accessed and the accessed data may be analyzed based on the rules from rules engine 208.

In an embodiment, a rule may be based on accessed customer data across a plurality of accounts for the customer. For example, the accessed data may comprise data from one or more customer accounts that do not comprise credit accounts, such as a debit account, an investment account, a retirement account, or any other suitable account, and a rule may be based on data from the one or more customer accounts. In an embodiment, a rule may be based on accessed data from at least two customer accounts that do not comprise credit accounts. For example, the accessed data may comprise data from a checking account and an investment account and a rule may be based on data from the at least two customer accounts.

In an embodiment, a rule may be based on accessed customer data from a personal account and a business account. For example, the accessed data may comprise data from a personal account, such as a personal checking account, and a business account, such as a business checking account, and a rule may be based on data from the personal account and a business account. In an embodiment, the accessed personal account and/or the accessed business account may comprise data from one or more customer accounts that do not comprise credit accounts, and a rule may be based on data from the personal account and a business account. For example, the accessed data may comprise data from a personal checking account and data from a business loan. In another example, the accessed data may comprise data from a personal line of credit and data from a business checking account.

The process of FIG. 3 may proceed from step 303 to step 304, where it is determined whether additional data should be pulled. For example, based on the analysis from step 303, it may be determined whether additional data should be pulled from third party sources 206 or from one or more credit bureaus. For example, database 205 may store a first degree of information about a customer, and if the first degree of information is below a threshold, it may be determined that additional data should be pulled. In another example, based on an analysis for the accessed data, a confidence level may be determined for a credit decision about the received request. If the confidence level is below a threshold, it may be determined that additional data should be pulled.

In an embodiment, if database 205 stores only one account for a customer, it may be determined that additional data should be pulled. In another embodiment, if database 205 stores credit bureau data that is older than a threshold, it may be determined that additional data should be pulled. In an embodiment, if database 205 stores only one of personal or business account data, it may be determined that additional data should be pulled. In an embodiment, if database 205 stores customer data for a duration of time below a threshold, such as customer data for a duration of time shorter than three years, it may be determined that additional data should be pulled.

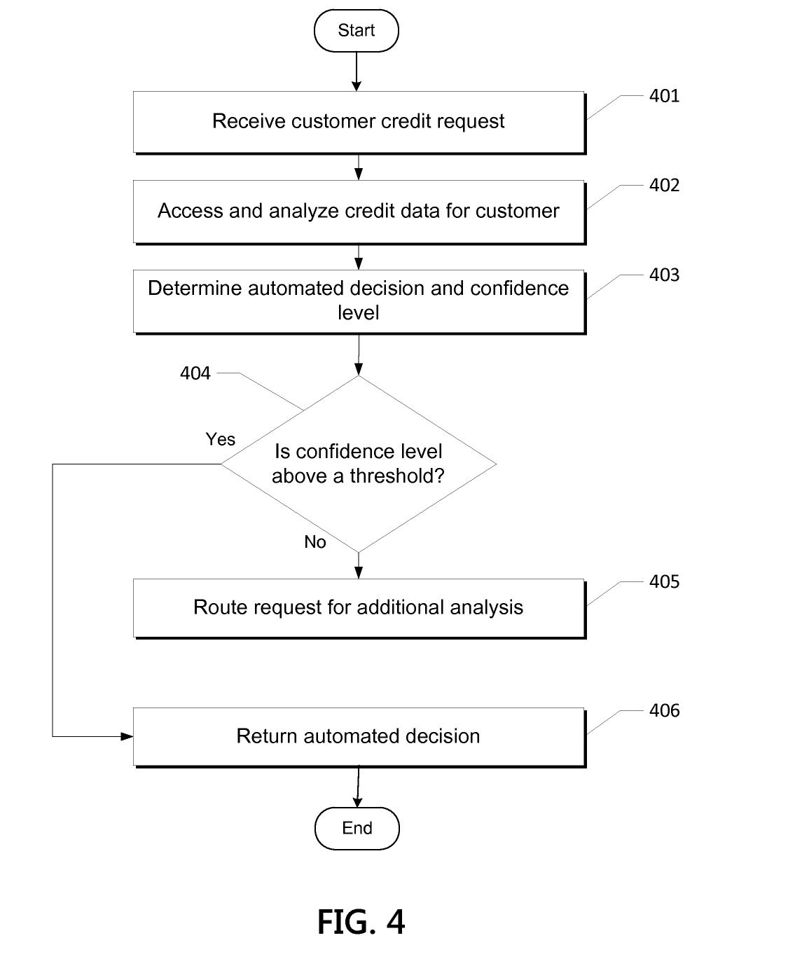

If it is determined that additional data should not be pulled, the process of FIG. 3 may proceed from step 304 to step 307, where a credit decision may be determined. For example, a credit decision may be determined based on the accessed and analyzed customer data. A credit decision may comprise granting or denying the received credit request. In an embodiment, a credit decision may be made according to the method steps of FIG. 4.

If it is determined that additional data should be pulled, the process of FIG. 3 may proceed from step 304 to step 305, where the additional data to be pulled is determined. For example, it may be determined that a credit report should be pulled from one or more credit bureaus based on database 205 storing a credit report that is older than a threshold. In another embodiment, it may be determined that a report should be retrieved from one or more third party sources.

The process of FIG. 3 may proceed from step 305 to step 306, where the determined additional data is pulled. For example, the additional data determined from step 305 may be pulled from, for example, one or more credit bureaus or one or more third party sources. The process of FIG. 3 may proceed from step 306 to step 307, where a credit decision may be determined. For example, the credit decision may be determined based on the accessed and analyzed customer data and/or based on the additional pulled data. A credit decision may comprise granting or denying the received credit request. In an embodiment, a credit decision may be made according to the method steps of FIG. 4.

In an embodiment, a credit decision may comprise a suggested substitute credit action. For example, a credit decision may comprise substituting a credit action for the received credit request. In this example, a credit request may comprise a loan, and a substitute credit action may comprise suggesting that the customer withdraw from/borrow from one or more of the customer's accounts administered by the financial institution. For instance, a financial institution may administer one or more retirement accounts for the customer, such as a 401k or an IRA, and a suggested credit action may comprise suggesting a customer borrow from/withdraw from one or more retirement accounts.

In an embodiment, the substitute credit action may be suggested based on one or more rules stored in rules engine 208. For example, the substitute credit action may be suggested based on a determination that the received credit request should be denied and that the suggested credit action may be available and may be useful for the customer. For instance, an analysis of the rules stored in rules engine 208 may determine that a loan should be denied for a customer, but that the customer has one or more retirement accounts administered by the financial institution. Accordingly, a determination may be made that borrowing from/withdrawing from the one or more retirement accounts may be useful to the customer and this credit action may be suggested to the customer. In another example, a suggested credit action may comprise suggesting a credit action based on an asset, such as a home equity line of credit.

In another embodiment, the substitute credit action may be suggested based on a determination that the suggested credit action comprises less of a credit risk, for the financial institution and/or the customer, than the received credit request. For instance, an analysis of the rules stored in rules engine 208 may determine that borrowing from/withdrawing from the one or more retirement accounts may be less of a credit risk, for the financial institution and/or the customer, than a loan that the customer is seeking with the received credit request. Accordingly, this credit action may be suggested to the customer. In another example, a suggested credit action may comprise suggesting a credit action based on an asset, such as a home equity line of credit.

FIG. 4 illustrates an example method for automatically determining a credit decision in accordance with an embodiment. In an embodiment, the example system integrated credit decision framework illustrated in FIG. 2 may perform the process of FIG. 4. In an embodiment, the method steps of FIG. 3 may further comprise the method steps of FIG. 4.

The process of FIG. 4 may start at step 401, where a credit request is received. For example, credit request 201 may be received at integrated credit decision platform 202. The received credit request may comprise a personal credit request or a business credit request. For example, the a personal credit request may comprise a request to issue and/or update a consumer credit card, a request for a home equity line of credit, or any other suitable personal credit request. A business credit request may comprise a request to issue and/or update a business credit card, a request for a business loan, or any other suitable business credit request.

The process of FIG. 4 may proceed from step 401 to step 402, where credit data for the customer may be accessed. In an embodiment, step 402 of FIG. 4 may comprise the methods steps 302-306 of FIG. 3. For example, account data for the customer from database 205 may be accessed and analyzed. In an embodiment, any data for the customer stored in database 205 may be accessed. In another example, account data for the customer from database 205 may be accessed and additional data, for instance from third party sources or credit bureaus, may be retrieved, and accessed and retrieved data may be analyzed.

The process of FIG. 4 may proceed from step 402 to step 403, where an automated decision with a confidence level may be determined. For example, an automated credit decision with a confidence level may be determined based on the analysis of the customer data from step 402. In an embodiment, the confidence level may be based on a duration for the customer data, such as an age for account data available for the customer, an amount of customer data, such as the number of accounts from which data was accessed, a date for customer data, such as a date for the latest credit report data available for a customer, a diversity for customer data, such as the types of accounts (e.g., personal or business) from which data was accessed, and any other suitable factors, or any combination of these. In an embodiment, the automated decision may be based on rules stored in rules engine 208.

The process of FIG. 4 may proceed from step 403 to step 404, where it is determined whether a confidence level is above a threshold. For example, an automated credit decision with a confidence level may be determined in step 403, and the confidence level may be compared to a threshold. In an embodiment, the threshold may be based on the type of credit request. For example, the confidence level may be compared to a first threshold where the request comprises an increase in a line of credit for a credit card, such as a consumer or business credit card, and the confidence level may be compared to a second threshold when the request comprises a request for a new line of credit, such as a new home equity line of credit. The second threshold may be higher than the first threshold.

In another embodiment, the threshold may be based on a risk to the financial institution associated with granting the credit request. For example, the confidence level may be compared to a first threshold where the request would expose the financial institution to a first level of risk, and the confidence level may be compared to a second threshold when the request would expose the financial institution to a second level of risk. The second level of risk may be higher than the first level of risk and the second threshold may be higher than the first threshold.

If it is determined that the confidence level is above a threshold, the process of FIG. 4 may proceed from step 404 to step 406, where the automated decision may be returned. For example, the received customer request may be granted or denied based on the returned automated decision.

If it is determined that the confidence level is below a threshold, the process of FIG. 4 may proceed from step 404 to step 405, where the request is routed for additional analysis. For example, the request may be routed to one or more individuals, such as financial institution employees or independent contractors, and the individuals may return a credit decision based on the accessed and analyzed customer data. The received customer request may be granted or denied based on the returned manual decision.

In an embodiment, a combination of the processes of FIGS. 3 and 4 may be used to determine a credit decision. For example, it may be determined that additional data should be pulled in order to raise a confidence level for an automated decision. In an embodiment, an automated decision may be determined with a first confidence level, such as in step 403 of FIG. 4. It may be determined that additional data should be pulled in order to raise the first confidence level. For example, at step 304 of FIG. 3, it may be determined that additional data should be pulled, so that the additional data may be used to raise a first confidence level above a threshold. In this example, it may be determined that a credit bureau should be polled if a refreshed credit report will raise the first confidence level over a threshold.

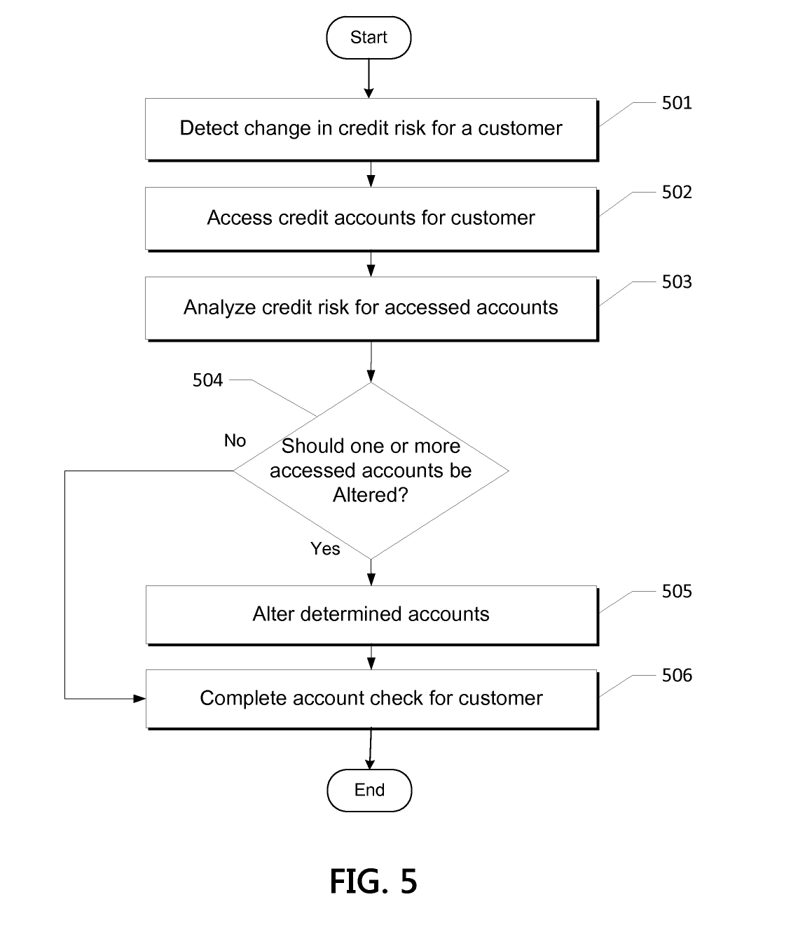

FIG. 5 illustrates an example method for adjusting a credit account for a customer based on a detected change in credit in accordance with an embodiment. In an embodiment, the example system integrated credit decision framework illustrated in FIG. 2 may perform the process of FIG. 5. The process of FIG. 5 may start at step 501, where a change in credit risk for a customer is detected. For example, a change in a credit risk for a customer may comprise a change in income, a change in credit score, a change in the delinquency status for an account, a change in balance for one or more accounts, a change in total credit available, or any other suitable change in credit risk. In an embodiment, a change in credit risk may be based on a granted credit request, for example a credit request granted through the process of FIG. 3.

The process of FIG. 5 may proceed from step 501 to step 502, where credit accounts are accessed for the customer. For example, one or more personal credit accounts, such as a consumer credit card account, line of credit, loan, or any other suitable personal credit account, or one or more business credit accounts, such as a business credit card account, line of credit, loan, or any other suitable business credit account, may be accessed. The process of FIG. 5 may proceed from step 502 to step 503, where a credit risk may be analyzed for the accessed credit accounts. For example, the credit accounts accessed in steps 502 may be analyzed based on the change in credit risk detected in step 503. In an embodiment, the accessed accounts may be analyzed based on rules stored in rules engine 208.

The process of FIG. 5 may proceed from step 503 to step 504, where it is determined whether one or more accessed accounts should be altered. For example, based on the analysis performed in step 503, one or more accessed credit accounts may be altered

In an embodiment, a change in credit risk for a customer's business credit account may be detected, and it may be determined that one or more of the customer's personal credit accounts should be altered. For example, a delinquency status for a business credit account may be detected, and it may be determined that one or more of the customer's personal credit accounts, such as a consumer credit card or a line of credit, should be altered.

In an embodiment, a change in credit risk for a customer's personal credit account may be detected, and it may be determined that one or more of the customer's business credit accounts should be altered. For example, a delinquency status for a personal credit account may be detected, and it may be determined that one or more of the customer's business credit accounts, such as a business credit card or a line of credit, should be altered.

In an embodiment, a change in credit risk for a customer's personal data may be detected, and it may be determined that one or more of the customer's business credit accounts or personal credit accounts should be altered. For example, a change in income for a customer may be detected, and it may be determined that one or more of the customer's personal credit accounts or business credit accounts, such as a credit card or a line of credit, should be altered.

If it is determined that one or more of the accessed accounts should be altered, the process of FIG. 5 may proceed from step 504 to step 505, where the determined accounts are altered. For example, it may be determined that one or more of a customer's personal credit accounts or business credit accounts should be altered, and these determined accounts may be altered based on the determination. In this example, a credit line for a consumer credit card may be decreased based on a detected drop in personal income for a customer.

If it is determined that none of the accessed accounts should be altered, the process of FIG. 5 may proceed from step 504 to step 506, where the account check for the detected change in credit risk is complete.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computer implemented method, comprising:
receiving, at a computing device of a financial institution, a credit request from a customer of the financial institution;
accessing aggregated financial data for the customer maintained by the financial institution, wherein the aggregated financial data comprises at least data from a debit account administered by the financial institution, a credit account administered by the financial institution, and personal data for the customer;
analyzing the accessed financial data based on rules, wherein the rules are configured based on a type for the received credit request;
determining, based on the analysis, whether additional financial data for the customer should be pulled from one or more third parties;
pulling additional financial data for the customer from one or more third parties when it is determined that additional financial data should be pulled; and
determining a credit decision about the credit request based on the accessed financial data and the additional financial data.

2. A method of claim 1, further comprising:
determining an automated credit decision for the credit request with a confidence level based on the accessed financial data;
comparing the confidence level to a threshold, wherein the threshold is based on a type for the received credit request;
returning the automated credit decision when it is determined that the confidence level is above the threshold; and
routing the credit request for additional processing such that a manual decision may be returned when it is determined that the confidence level is below the threshold.

3. A method of claim 2, wherein determining whether additional financial data for the customer should be pulled further comprises:
determining whether additional financial data will raise the confidence level of the automated credit decision above the threshold;
determining to pull the additional financial data when it is determined that the additional financial data will raise the confidence level of the automated credit decision above the threshold.

4. A method of claim 1,
wherein the personal financial data for the customer comprises at least one of a demographic, an income, an occupation, a citizenship, and a residency status, and
wherein the rules comprise at least one rule associated with the accessed personal financial data.

5. A method of claim 1,
wherein the accessed financial data for the customer comprises accessing at least data from a personal account for the customer and data from a business account for the customer, and
wherein the rules comprise at least one rule associated with the accessed personal account data and the accessed business account data.

6. A method of claim 5, wherein the rules comprise at least one rule that associates a personal credit request with accessed financial data for the customer's business account.

7. A method of claim 5, wherein the rules comprise at least one rule that associates a business credit request with accessed financial data for the customer's personal account.

8. A method of claim 1, wherein the determined credit decision comprises a suggested substitute credit action for the customer.

9. A method of claim 1, further comprising:
detecting a change in a credit risk for the customer, wherein the detecting is based on monitoring financial data for the customer maintained by the financial institution;
accessing a plurality of credit accounts for the customer maintained by the financial institution;
determining whether to alter the accessed credit accounts based on the detected change in credit risk; and
altering the accessed credit accounts when it is determined that the accessed credit accounts should be altered.

10. A method of claim 9, wherein the received customer request is granted and the detected change in credit risk for the customer comprises the granted request.

11. A system comprising:
a first computing device, with a processor, configured to:
receive a credit request from a customer of the financial institution;
access aggregated financial data for the customer maintained by the financial institution, wherein the aggregated financial data comprises at least data from a debit account administered by the financial institution, a credit account administered by the financial institution, and personal data for the customer;
analyze the accessed financial data based on rules, wherein the rules are configured based on a type for the received credit request;
determine, based on the analysis, whether additional financial data for the customer should be pulled from one or more third parties;
pull additional financial data for the customer from one or more third parties when it is determined that additional financial data should be pulled; and
determine a credit decision about the credit request based on the accessed financial data and the additional financial data.

12. A system of claim 11, wherein the first computing device is further configured to:
determine an automated credit decision for the credit request with a confidence level based on the accessed financial data;
compare the confidence level to a threshold, wherein the threshold is based on a type for the received credit request;
return the automated credit decision when it is determined that the confidence level is above the threshold; and
route the credit request for additional processing such that a manual decision may be returned when it is determined that the confidence level is below the threshold.

13. A system of claim 12, wherein determining whether additional financial data for the customer should be pulled further comprises:
determining whether additional financial data will raise the confidence level of the automated credit decision above the threshold;
determining to pull the additional financial data when it is determined that the additional financial data will raise the confidence level of the automated credit decision above the threshold.

14. A system of claim 11,
wherein the personal financial data for the customer comprises at least one of a demographic, an income, an occupation, a citizenship, and a residency status, and
wherein the rules comprise at least one rule associated with the accessed personal financial data.

15. A system of claim 11,
wherein the accessed financial data for the customer comprises accessing at least data from a personal account for the customer and data from a business account for the customer, and
wherein the rules comprise at least one rule associated with the accessed personal account data and the accessed business account data.

16. A system of claim 15, wherein the rules comprise at least one rule that associates a personal credit request with accessed financial data for the customer's business account.

17. A system of claim 15, wherein the rules comprise at least one rule that associates a business credit request with accessed financial data for the customer's personal account.

18. A system of claim 11, wherein the determined credit decision comprises a suggested substitute credit action for the customer.

19. A system of claim 11, wherein the first computing device is further configured to:
detect a change in a credit risk for the customer, wherein the detecting is based on monitoring financial data for the customer maintained by the financial institution;
access a plurality of credit accounts for the customer maintained by the financial institution;
determine whether to alter the accessed credit accounts based on the detected change in credit risk; and
alter the accessed credit accounts when it is determined that the accessed credit accounts should be altered.

20. One or more non-transitory computer readable media having stored thereon instructions that, when executed by an apparatus, cause the apparatus to:
receive a credit request from a customer of a financial institution;
access aggregated financial data for the customer, wherein the aggregated financial data comprises at least data from a debit account administered by the financial institution, a credit account administered by the financial institution, and personal data for the customer;
analyze the accessed financial data based on rules, wherein the rules are configured based on a type for the received credit request;
determine, based on the analysis, whether additional financial data for the customer should be pulled from one or more third parties;
pull additional financial data for the customer from one or more third parties when it is determined that additional financial data should be pulled; and
determine to permit or deny the credit request based on the accessed financial data and the additional financial data.
